(19) United States
(12) Patent Application Publication
(10) Pub. No.: US 2025/0293806 A1
(43) Pub. Date: Sep. 18, 2025

(54) SYSTEMS AND METHODS FOR FRAME STRUCTURES FOR COMMUNICATION IN PASSIVE/SEMI-PASSIVE INTERNET-OF-THINGS

(71) Applicant: ZTE CORPORATION, Shenzhen (CN)

(72) Inventors: Luanjian BIAN, Shenzhen (CN); Bo DAI, Shenzhen (CN); Youjun HU, Shenzhen (CN); Kun LIU, Shenzhen (CN); Weiwei YANG, Shenzhen (CN)

(73) Assignee: ZTE CORPORATION, Shenzhen (CN)

(21) Appl. No.: 18/900,111

(22) Filed: Sep. 27, 2024

Related U.S. Application Data
(63) Continuation of application No. PCT/CN2022/104438, filed on Jul. 7, 2022.

(51) Int. Cl. H04L 1/08

(52) U.S. Cl. CPC H04L 1/08

(57) ABSTRACT

Presented are systems and methods for frame structures for communication in passive/semi-passive Internet-of-Things (IoT). A first wireless communication device may determine a number (N) of repetitive transmissions for data. The first wireless communication device may send data using a frame structure to a second wireless communication device. The frame structure may include a preamble sequence and the data with the N repetitions.

### CROSS-REFERENCE TO RELATED APPLICATION

This application claims the benefit of priority under 35 U.S.C. § 120 as a continuation of International Patent Application No. PCT/CN2022/104438, filed on Jul. 7, 2022, the disclosure of which is incorporated herein by reference in its entirety.

### TECHNICAL FIELD

The disclosure relates generally to wireless communications, including but not limited to systems and methods for frame structures for communication in passive/semi-passive Internet-of-Things (IoT).

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A first wireless communication device may determine a number (N) of repetitive transmissions for data. The first wireless communication device may send data using a frame structure to a second wireless communication device. The frame structure may include a preamble sequence and the data with the N repetitions.

In some embodiments, the frame structure may include the preamble sequence, a first one of the N repetitions, a tail sequence, and remaining ones of the N repetitions that can be arranged in above order along a time domain. In some embodiments, the frame structure may include the preamble sequence, control information with a number (M) of repetitions, and the data with the N repetitions that are arranged in above order along a time domain. In some embodiments, the frame structure may include the preamble sequence, control information for the first one of a number (M) of repetitions, a tail sequence, control information for remaining ones of the M repetitions, and the data with the N repetitions that can be arranged in above order along a time domain.

In some embodiments, the frame structure may include the preamble sequence and the data with the N repetitions that can be arranged in above order along a time domain. Prior to sending the data using the frame structure, the first wireless communication device may receive a first message from the second first wireless communication device. The first wireless communication device may determine a data sequence length of each of the N repetitive transmissions based on the message. The step of determining a length of each of the N repetitive transmissions may further comprise the following steps. Each type of first message may correspond to a data sequence length. The first wireless communication device may determine the data sequence length of each of the N repetitive transmissions according to the type of the received first message.

In some embodiments, each type of first message corresponds to a set of data sequence lengths, J≥1. The first message may contain a length indication indicating one of the set of data sequence lengths. In some embodiments, a tail sequence can be arranged after the N repetitive transmissions along the time domain.

In some embodiments, the preamble sequence can be configured to indicate an arrangement of the frame structure. The arrangements of the frame structures may include at least one of: whether to perform the repetitive transmissions, a length of data sequence, a subset of lengths of data sequence, a subset of the number of repetitive transmissions for data, a length of control signals, or a subset a number of repetitive transmissions for control signals.

In some embodiments, the frame structure further may include one or more head symbols configured to indicate an arrangement of the frame structure. The frame structure may include the preamble sequence, the one or more head symbols, the data for the first one of the N repetitions, the tail sequence, and the data for remaining ones of the N repetitions that can be arranged in above order along a time domain. The frame structure may include the preamble sequence, the one or more head symbols, and the data with the N repetitions that can be arranged in above order along a time domain. The frame structure may include the preamble sequence, the one or more head symbols, control information with a number (M) of repetitions, and the data with the N repetitions that can be arranged in above order along a time domain. The frame structure may include the preamble sequence, the one or more head symbols, the data with the N repetitions, and the tail sequence that can be arranged in above order along a time domain.

In some embodiments, a second wireless communication device may receive data using a frame structure from a first wireless communication device. The frame structure may include a preamble sequence and data with a number (N) of repetitions.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure.

FIG. 2 illustrates a block diagram of an example base station and a user equipment device, in accordance with some embodiments of the present disclosure.

FIG. 3 illustrates a frame structure for communication in passive/semi-passive Internet-of-Things (IoT), in accordance with an embodiment of the present disclosure.

FIG. 4 illustrates a frame structure for communication in passive/semi-passive Internet-of-Things (IoT), in accordance with an embodiment of the present disclosure.

FIG. 5 illustrates a frame structure for communication in passive/semi-passive Internet-of-Things (IoT), in accordance with an embodiment of the present disclosure.

FIG. 6 illustrates a frame structure for communication in passive/semi-passive Internet-of-Things (IoT), in accordance with an embodiment of the present disclosure.

FIG. 7 illustrates a frame structure for communication in passive/semi-passive Internet-of-Things (IoT), in accordance with an embodiment of the present disclosure

FIG. 8 illustrates a frame structure for communication in passive/semi-passive Internet-of-Things (IoT), in accordance with an embodiment of the present disclosure.

FIG. 9 illustrates a frame structure for communication in passive/semi-passive Internet-of-Things (IoT), in accordance with an embodiment of the present disclosure.

FIG. 10 illustrates a frame structure for communication in passive/semi-passive Internet-of-Things (IoT), in accordance with an embodiment of the present disclosure.

FIG. 11 illustrates a frame structure for communication in passive/semi-passive Internet-of-Things (IoT), in accordance with an embodiment of the present disclosure.

FIG. 12 illustrates a flow diagram for communication in passive/semi-passive Internet-of-Things (IoT), in accordance with an embodiment of the present disclosure

### DETAILED DESCRIPTION

### 1. Mobile Communication Technology and Environment

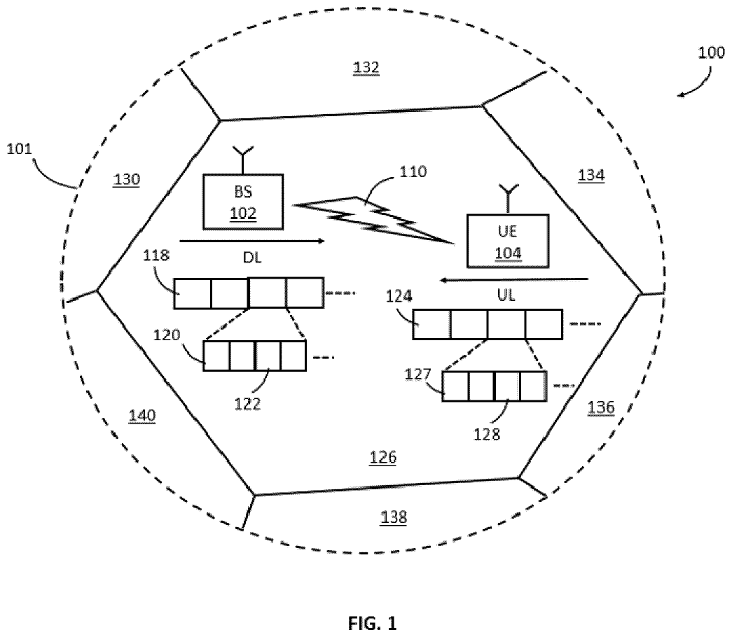

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

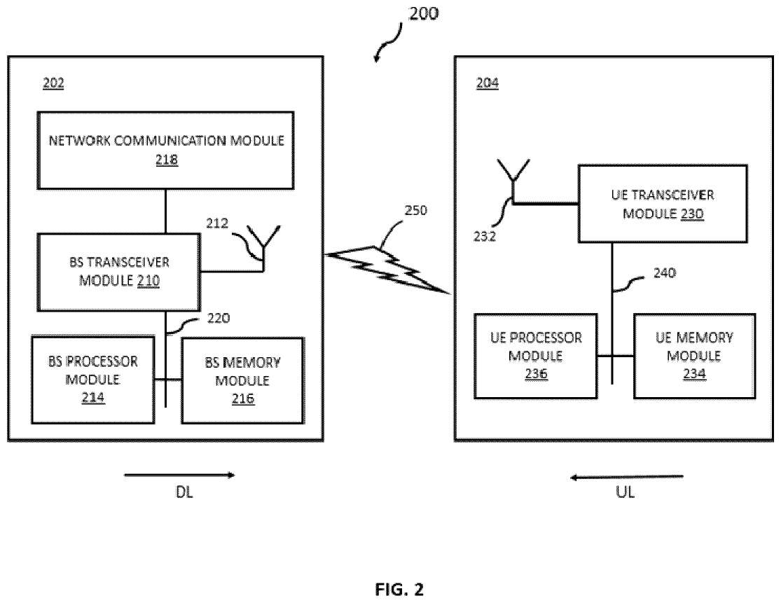

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuity that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (NB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that use bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to use a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Frame Structures for Communication in Passive/Semi-Passive Internet-of-Things (IoT)

In passive/semi-passive Internet-of-Things (IoT) communication technology, information can be sent and/or received with a fixed frame structure. A frame structure signal may include a frame header, data, and a frame tail. The frame header and the frame tail can be bit sequences or high/low level signals with a fixed form. The frame header can be used to determine a start of a frame structure signal. The frame tail can be used to determine an end of a frame structure signal. The frame header and the frame tail can be used to determine information transmission duration, a number of data ratio symbols, and/or data sequence length of the frame structure signal.

In order to expand a coverage of passive/semi-passive IoT communication, a method for repetitive data transmissions can improve a signal-to-noise ratio of received data. The method may increase a communication distance between a transmitting node and a receiving node. However, in the case of repetitive transmissions, if the frame header and the frame trail are sent for each repetitive transmission, communication resources can be wasted. The repetitive transmission may reduce a transmission efficiency and may increase a power consumption. If the frame header and the frame tail are not sent, a synchronous reception of the signal may be affected. Therefore, in the repetitive transmissions of passive IoT communication, a form of frame structure may be investigated. The present invention proposes a frame structure signal transmission method to improve the repetitive transmission efficiency of passive communication.

In some embodiments, a first communication node can be a transmitting node. A second communication node can be a receiving node.

### Implementation Example 1

In some embodiments, a first communication node may determines a number of repetitions of a data sequence N according to a frame structure. The frame structure may include a preamble sequence, a data sequence of a first transmission, a tail sequence, and a data sequence of a 2^{nd} transmission to an N^{th} transmission. N can be greater than or equal to 1.

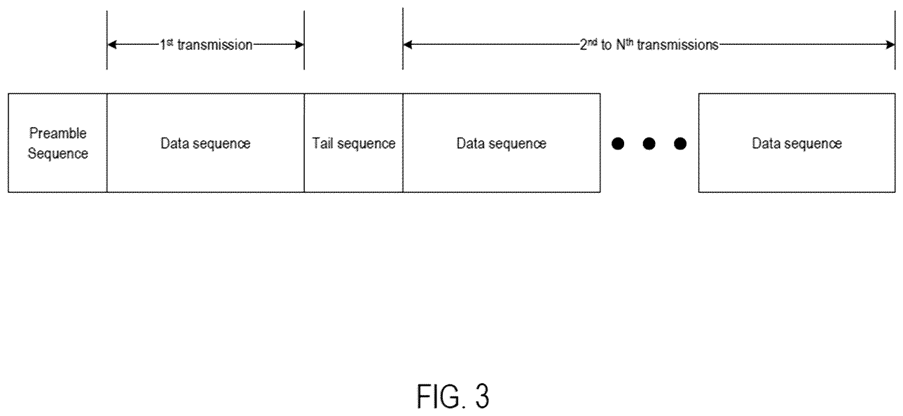

The frame structure may sequentially include in a time domain: a preamble sequence, a data sequence of a first transmission, a tail sequence, and a data sequence of a second transmission to an Nth transmission, as shown in FIG. 3. For example, sending the data sequence of Nth repetitive transmissions according to the frame structure may include successively sending the preamble sequence, the data sequence of the first transmission, the tail sequence, and the data sequence of the second transmission to the Nth transmission in sequence.

For the data sequence transmitted repeatedly for N times, the preamble sequence can be added before the data sequence transmitted for the first time, and the tail sequence can be appended after the data sequence transmitted for the first time. The data sequences of the second to Nth transmissions can be sent continuously. Preamble sequence or tail sequence may not be added between each transmission of the second to Nth transmissions.

When N is equal to 1, the N repeated transmissions can be single transmissions. In such case, the first communication node may send the data sequence once. There may not be any transmitted data sequence of second transmission to Nth transmissions. When N is greater than 1, the N repeated transmissions can be multiple transmissions. In this case, the first communication node may send the data sequence N times.

In some embodiments, a second communication node may determine a start time of the data sequence according to the preamble sequence. The preamble sequence can be used for synchronization. In the case of detecting the preamble sequence, the second communication node may determine the start time of the data sequence and may receive the data sequence synchronously. For the data sequence transmitted repeatedly for N times, when the second communication node detects the preamble sequence, the second communication node may determine the start time of the first transmission of the data sequence and may synchronously receive the N times data sequence transmissions. The preamble sequence can be a signal with S fixed formats, e.g., a sequence of complex numbers with S formats, or a fixed high and low level signal. S can be greater than or equal to 1.

In some embodiments, the second communication node may use the tail sequence to determine the length of the data sequence. The tail sequence may be used to determine the transmission duration of the data sequence or the length of the data sequence. The length of the data sequence can be the number of data symbols included in the data sequence. The transmission duration of the data sequence may correspond to the length of the data sequence. In the case of detecting the tail sequence, the second communication node may determine the end time of the first transmission of the data sequence and may determine the length of the data sequence.

The first communication node may send a data sequence. The data sequence may include K optional data sequence lengths. Each of the data sequence lengths can be used as a number of candidate symbols. The second communication node may receive the data sequence and may detect the tail sequence if the number of candidate symbols is received. If a tail sequence is detected for a certain number of candidate symbols, the second communication node may determine that the first transmission of the data sequence can be over, and may determine that the number of candidate symbols can be the length of the data sequence. The data sequence may include the number of data symbols.

The data sequence received by the second communication node may have K possible data sequence lengths (e.g., K number of candidate symbols). The K number of candidate symbols can be sorted from small to large. The second communication node may receive the data sequence. The second communication node may try to detect the tail sequence after the first data symbol of the K number of candidate symbols. If the tail sequence is detected, the second communication node may determine that the length of the data sequence can be the number of the first candidate symbol. If the tail sequence is not detected, the second communication node may try to detect the tail sequence after the second data symbols of the K number of candidate symbols. If the tail sequence is detected, the second communication node may determine that the length of the data sequence can be the number of the second candidate symbol. If the tail sequence is not detected, the second communication node may try to detect the tail sequence after the third data symbols of the K number of candidate symbols. The second communication node may continue detecting the tail sequence after the Nth data symbol of the K number of candidate symbols, and so on. The tail sequence may be detected after the data symbols of the Kth candidate symbol number at most. N can be equal to or smaller than K. The length of the data sequence may be equivalent to the transmission duration. The number of data symbols included in the data sequence can be represented by the transmission duration. Each of the candidate quantities can be a candidate transmission duration.

In some embodiments, the second communication node may determine the number of repetitive transmissions for the data sequence by decoding. After determining the length of the data sequence, the second communication node may decode the data sequence data. For a data sequence, R optional number of repetitions can be configured. The data sequence transmission may use one of the R types of the repetitive transmissions. Each number of the one of the R types repetitive transmissions may be used as a candidate repetition number. The second communication node may receive the data sequence, and may decode the data sequence when receiving the data sequence of the repetitive transmissions.

A configurable number of repetitive transmissions for the data sequence may include N₁, N₂, . . . , N_{R}. The number of repetitive transmissions for data can be N₁, N₂, . . . , or N_{R}. N₁, N₂, . . . , NR can be the number of candidate repetitive transmissions. The second communication node may receive the data sequence, and may decode the data sequence when receiving the data sequence for N₁ times. If the decoding is successful, the second communication node may stop receiving the data sequence. If the decoding is successful, the second communication node may decode the data sequence when the data sequence is received N₂ times. If the decoding is successful, the second communication node may stop receiving the data sequence. If the decoding is unsuccessful, the second communication node may try to decode the data sequence when the data sequence is received N₃ times, and so on. The system may support trying to decode the data sequence when the data sequence is received N_{R} times at most. The data sequence may include indication information of the repetitive transmissions. The indication information of the repetitive transmissions may indicate the number of repetitions of the data sequence. The second communication node may determine the number N of repetitions of the data sequence if the data is correctly decoded. Furthermore, the second communication node may determine an end time of N repetitive transmissions of the data sequence.

### Implementation Example 2

A first communication node may determine a number of repetitions M of control information and a number of repetitions N of a data sequence. M and N can be greater than or equal to 1. The first communication node may send a preamble sequence, the control information with M repeated transmissions, and the data sequence with N repeated transmissions according to the frame structure. The number M of repetitions of the control information and the number N of repetitions of the data sequence may be equal (e.g., M=N). The first communication node may configure the same number of repetitions for the control information and the data sequence. The first communication node may send the control information that can be repeatedly transmitted M times according to the frame structure. When M is equal to 1, the M repeated transmissions can be a single transmission. In such case, the first communication node may send the control information once. When M is greater than 1, the M repeated transmissions can be multiple transmissions. In such case, the first communication node may send the control information M times.

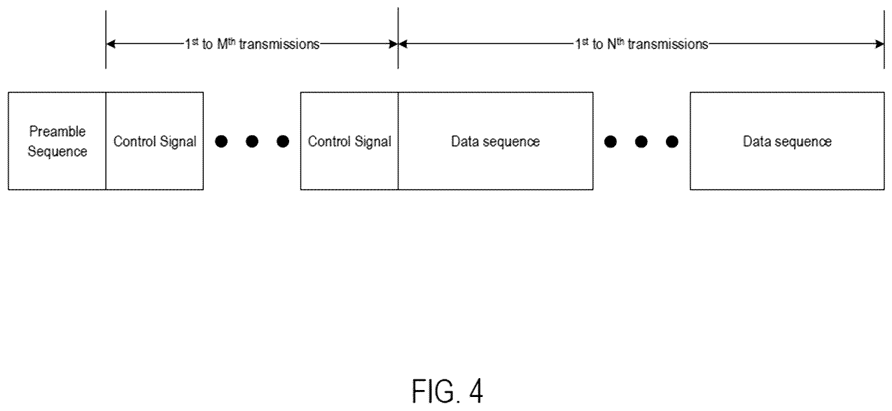

The first communication node may send a data sequence repeatedly transmitted N times according to the frame structure. When N is equal to 1, the N repeated transmissions can be a single transmission. In such case, the first communication node may send the data sequence once. When N is greater than 1, the N repeated transmissions can be multiple transmissions. In such case, the first communication node may send the data sequence N times. The frame structure sequentially in the time domain may include: a preamble sequence, control information transmitted in the 1^{st} to M^{th} times, and data sequences transmitted in the 1^{st} to N^{th} times, as shown in FIG. 4. The preamble sequence can be used for synchronization of data sequence transmission. When the second communication node detects the preamble sequence, the start time of the control information may be determined. The preamble sequence can be a signal with S fixed formats. S can be greater than or equal to 1. The control information may include at least one of the following indications: an indication of the number of repetitions of the control information, an indication of the number of repetitions of the data sequence, or an indication of the number of data symbols of the data sequence.

In some embodiments, the second communication node may receive the control information. The control information may have L information lengths. L can be greater than or equal to 1. The information length can be the number of information bits. For decoding of the control information, the following two optional methods can be included.

### Method One

In this method, the control information may have a fixed information length when L is equal to 1. The second communication node may decode the control information based on the fixed information length. The configurable number of repetitions for the control information may include M₁, M₂, . . . , M_{R}. M₁, M₂, . . . , M_{R} can be used as candidate number of repetitions. The second communication node may receive the control information, and may decode the control information when receiving the control information with the number of candidate repetitions. The second communication node may decode the control information when receiving the control information with the number of repetitions M₁. If the decoding is successful, the second communication node may stop receiving the control information. If the decoding is unsuccessful, the second communication node may decode the control information when receiving the control information with the number of repetitions M₂. If the decoding is successful, the second communication node may stop receiving the control information. If the decoding is unsuccessful, the second communication node may decode the control information when receiving the control information with the number of repetitions M₃, or so on. The second communication node may decode the control information when receiving the control information with the number of repetitions M_{R} at most.

### Method Two

In this method, the control information may have L fixed information lengths (e.g., C₁, C₂, . . . , C_{L}) when L is greater than 1. The control information has R configurable number of repetitions (e.g., M₁, M₂, . . . , M_{R}). The combination {Cₓ, M_{y}} of the information length and the number of repetitions of the control information can be used as a candidate decoding configuration, where Cₓ∈{C₁, C₂, . . . , C_{L}} and M_{y}∈{M₁, M₂, . . . , M_{R}}. The number of the candidate decoding configurations and the value of the {Cₓ, M_{y}} can be predefined, or may indicate to the second communication node by the indication information.

The second communication node may receive the control information, and may decode the control information when receiving the control information with the candidate decoding configuration. The second communication node may decode the control information when receiving the control information with number of repetitions M_{y} and the control information length Cₓ. For example, the candidate decoding configuration may include {C₁, M₁}, {C₁, M₂}, {C₂, M₁}, {C₂, M₂}. When the second communication node receives the control information with number of repetitions M₁ and the control information length C₁, the second communication node may decode the control information. If the decoding is successful, the second communication node may stop receiving the control information. If the decoding is unsuccessful, the second communication node may decode the control information when receiving the control information with number of repetitions M₂ and the control information length C₁. If the decoding is successful, the second communication node can stop receiving the control information. If the decoding is unsuccessful, the second communication node may decode the control information after receiving the control information with number of repetitions M₁ and the control information length C₂, or so on, until all candidate decoding configurations are tried at most.

In some embodiments, the second communication node may determine the data sequence length and the number of repetitions of the data sequence according to the control information. The control information may include an indication of number of repetitions of the control information. When the second communication node decodes the control information correctly, the second communication node may determine the number of repetitions used for the control information according to an indication of number of repetitions of the control information. Therefore, the second communication node may determine an end time of the last transmission of the control information and a start time of the first transmission of the data sequence.

The control information may include an indication of a number of data symbols of the data sequence. When the second communication node decodes the control information correctly, the second communication node may determine the number of data symbols of the data sequence according to the indication of the number of data symbols of the data sequence. The control information may include an indication of the number of repetitions of the data sequence. The data sequence and the control information may use the same number of repetitions. When the second communication node correctly decodes the control information, the second communication node may determine the number of repetitions used for the transmission of the data sequence. Furthermore, the second communication node may determine the end time of the last transmission of the data sequence. The second communication node may determine the number of the data symbols and the number of repetitions of the data sequence, and may decode the data sequence.

### Implementation Example 3

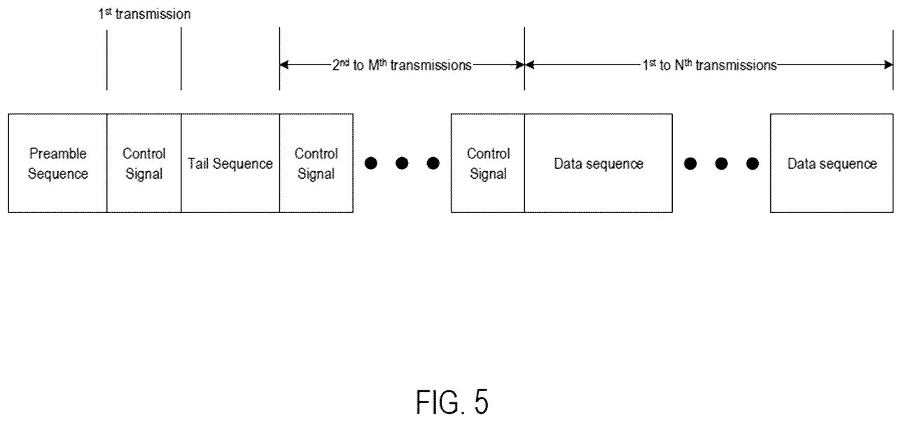

The first communication node may determine a number of repetitions M of the control information and a number of repetitions N of the data sequence. M and N can be greater than or equal to 1. The first communication node may send the control information for M repetitive transmissions and the data sequence for N repetitive transmissions according to the frame structure. The number M of repetitions of the control information and the number N of repetitions of the data sequence may be equal (e.g., M=N). The first communication node may configure the same number of repetitions for the control information and the data sequence. The frame structure sequentially in the time domain may include: a preamble sequence, control information of a first transmission, a tail sequence, control information of a second to M^{th} transmissions, and a data sequence of a first to N^{th} transmissions, as shown in FIG. 5.

The sending of the control information for the M repetitive transmissions and the data sequence for the N repetitive transmissions according to the frame structure may include: successively sending preamble sequences, control information of a first transmission, a tail sequence, control information for the 2^{nd} to Mₜₕ transmissions, and data sequences for the 1^{st} to N^{th} transmissions. The first communication node may send the control information that can be repeatedly transmitted M times according to the frame structure. When M is equal to 1, the M repetitive transmissions can be a single transmission. In such case, the first communication node may send the control information once. There can be no control information from the second transmission to the M^{th} transmission. When M is greater than 1, the M repetitive transmissions can be multiple transmissions. In such case, the first communication node may send the control information M times.

The first communication node may send a data sequence repeatedly for N times according to the frame structure. When N is equal to 1, the N repetitive transmissions can be a single transmission. In such case, the first communication node may send the data sequence once. When N is greater than 1, the N repetitive transmissions can be multiple transmissions. In such case, the first communication node may send the data sequence N times. The control information may include at least one of the following indications: an indication of the number of repetitions of the control information, an indication of the number of repetitions of the data sequence, or an indication of the number of data symbols of the data sequence.

In some embodiments, the second communication node may determine the start time of the control information. The preamble sequence can be used for synchronization of the data sequence transmission. When the second communication node detects the preamble sequence, the start time of the control information may be determined. The preamble sequence can be a signal with S fixed formats. The S can be greater than or equal to 1.

In some embodiments, the tail sequence can be used to determine the control information length. The control information length can be the number of bits of the control information. The second communication node may determine the control information length according to the tail sequence. Specifically, the second communication node may determine the control information length by detecting the tail sequence. For the control information transmitted repeatedly for the M times, when the second communication node detects the tail sequence, the second communication node may determine the end time of the first transmission of the control information, and may determine the control information length.

Furthermore, the control information may include K kinds of optional information lengths. Each of the information lengths may serve as a candidate information length. The second communication node may receive the control information, and detect the tail sequence if the control information of the information length is received. If a tail sequence is detected for a certain candidate information length, the second communication node may determine that the first transmission of the control information may end, and may further determine that the candidate information length can be the control information length (i.e., the number of bits contained in the control information).

The control information received by the second communication node may have K possible information lengths (e.g., K kinds of candidate information lengths). The K kinds of candidate information lengths can be sorted in ascending order. The second communication node may receive the control information, and may detect the tail sequence after the control information of the first candidate information length. If the tail sequence is detected, the second communication node may determine the information length of the control information to be the length of the first candidate information. If the tail sequence is not detected, the second communication node may detect the tail sequence after the control information of the second candidate information length. If the tail sequence is detected, the information length of the control information can be determined to be the length of the second candidate information. If the tail sequence is not detected, the second communication node may detect the tail sequence after the control information of the third candidate information length, or so on. The tail sequence can be detected after the control information of the K-th candidate information length at most.

In some embodiments, the second communication node may decode the control information. After determining the information length of the control information, the second communication node may decode the control information based on the information length. The configurable number of repetitions for the control information may include M₁, M₂, . . . , and M_{R}. The number of repetitions used for control information transmission can be one of M₁, M₂, . . . , or M_{R}. M₁, M₂, . . . , or M_{R} can be used as candidate number of repetitions. The second communication node may receive the control information, and may decode the control information when receiving the control information of the candidate number of repetitions. The second communication node may decode the control information when receiving the control information for M₁ times. If the decoding is successful, the second communication node may stop receiving the control information. If the decoding is not successful, the second communication node may decode the control information when receiving the control information M₂ times. If the decoding is successful, the second communication node may stop receiving the control information. If the decoding is unsuccessful, the second communication node may decode the control information when receiving the control information for M₃ times, and so on. When receiving the control information for M_{R} times at most, the second communication node may decode the control information.

In some embodiments, the second communication node may determine the length and the number of repetitions of the data sequence according to the control information. The control information may include an indication of the number of repetitions of the control information. When the second communication node decodes the control information correctly, the second communication node may determine the number of repetitions used for transmitting the control information according to the indication of the number of repetitions of the control information. The second communication node may determine the end time of the last transmission of the control information and the start time of the first transmission of the data sequence.

The control information may include an indication of the number of data symbols of the data sequence. When the second communication node decodes the control information correctly, the second communication node can determine the number of data symbols of the data sequence according to the indication of the number of data symbols of the data sequence. The control information may include an indication of the number of repetitions of the data sequence. The data sequence and the control information may use the same number of repetitions. When the second communication node correctly decodes the control information, the number of repetitions used for the data sequence transmissions can be determined. Furthermore, the second communication node may determine the end time of the last transmission of the data sequence. The second communication node may determine the number of data symbols and the number of repetitions of the data sequence, and may decode the data sequence.

### Implementation Example 4

The second communication node may receive first information from the first communication node. The second communication node may determine a length of second information according to the first information. The second information length may indicate a number of data symbols included in the second information. The second information can be a data sequence sent by the second communication node. The second information length can a data sequence length. The second information can be a response for the first information. Specifically, the second communication node may receive the first information, and may send response information for the first information. The response information can be the second information.

The length of the data sequence can be determined according to the first information, including the following three optional methods.
Method One: There can be H types of the first information. Each type of the first information may correspond to a length of the second information. The corresponding second information length can be determined according to the type of the first information by the second communication node.
Method Two: The first information may have H types. Each first information type may correspond to a second information length set. The second information length set may include J second information lengths. J can be greater than or equal to 1. There can be two or more types of first information which have different second information length sets. Therefore, a corresponding second information length set may be determined according to the first information type. The first information may include a second information length indication. In the second information length set corresponding to the first information, the second information length can be determined according to the second information length indication by the second communication node.
Method Three: The first information may include a second information length indication. The second information length can be determined according to the second information length indication by the second communication node.

In some embodiments, the second communication node may determine a number N of repetitions of the second information. The second communication node may determine the number N of repetitions of the second information, including the following two optional methods.
Method One: The second communication node may determine the number N of repetitions of the second information according to the number of repetitions of the received first information. For example, the second communication node may determine that the number of repetitions N of the second information can be greater than or equal to the number of repetitions of the received first information, so as to ensure that the second information can be correctly received and can improve transmission reliability.
Method Two: The first information may include an indication of the number of repetitions of the second information. The second communication node may determine the number of repetitions of the second information according to the indication of the number of repetitions of the second information.

In some embodiments, the second communication node may sequentially send the second information of the N repetitive transmissions according to the frame structure. The first communication node may send the second information repeatedly transmitted N times according to the frame structure. When N is equal to 1, the N repeated transmissions can be a single transmission. In such case, the first communication node may send the second information once. When N is greater than 1, the N repeated transmissions can be multiple times transmissions. In such case, the first communication node may send the second information N times.

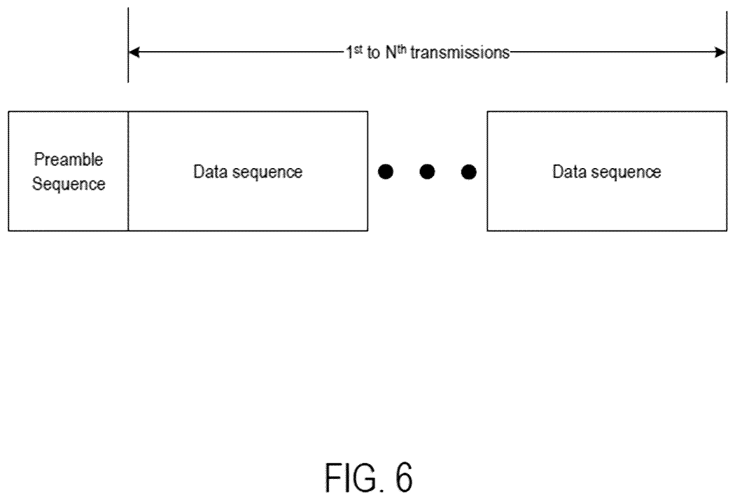

The frame structure sequentially in the time domain may include: a preamble sequence, second information for 1^{st} to N^{th} transmissions, as shown in FIG. 6. The data sequence can be the second information. The second information of N repetitive transmissions according to the frame structure may include: continuously and sequentially sending the preamble sequence and the second information of the 1^{st} transmission to the N^{th} transmission. For the data sequence transmitted repeatedly for N times, the preamble sequence can be added before the data sequence transmitted for the first time. The data sequences of the 2^{nd} to N^{th} transmissions can be sent continuously. No preamble sequence can be added between each transmission.

The preamble sequence can be used for synchronization. The first communication node may receive the second information. In the case of detecting the preamble sequence, the first communication node may determine the start time of the second information, and may receive the second information synchronously. For the second information transmitted repeatedly for N times, when the second communication node detects the preamble sequence, the second communication node may determine the start time of the first transmission of the second information, and may synchronously receive the second information of the N times transmissions. The preamble sequence can be a signal with S formats. S can be greater than or equal to 1.

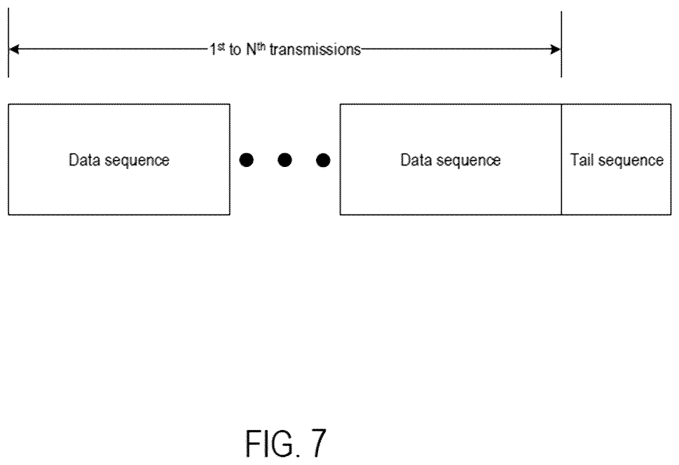

Optionally, the frame structure may include: appending a tail sequence after the data sequence transmitted for the N^{th} time, as shown in FIG. 7. A complete frame structure sequentially in the time domain may include: a preamble sequence, second information transmitted in the 1^{st} to N^{th} times, and a tail sequence. The second information can be a data sequence. The tail sequence can be a fixed format signal. The first communication node may determine the end time of the last transmission of the second information according to the tail sequence. The first communication node may determine the number of repetitions of the second information according to the tail sequence.

The set of numbers of repetitions for the second information can be {N¹, N², . . . , N^{R}}. When receiving the second information, the first communication node may detect a tail sequence when receiving the second information of the candidate number of repetitions. If a tail sequence is detected for a certain candidate repetition number, the second communication node may determine that the last transmission of the second information can be over, and may determine that the candidate repetition number can be the repetition number used by the second information.

### Implementation Example 5

A frame structure signal configuration can be indicated by a preamble sequence in a frame structure signal. The frame structure signal configuration may include at least one of: whether to use repetitive transmissions, a data sequence length, a subset of data sequence lengths, a subset of numbers of repetitions of data sequence, a control information length, or a subset of numbers of repetitions of control information. The preamble sequence in the preamble sequence set can indicate the frame structure signal configuration. The preamble sequence set may include K preamble sequences. Each preamble sequence can be a signal in a fixed format. K can be greater than or equal to 1. Each preamble sequence may correspond to one of the frame structure signal configurations. There can be a case that multiple preamble sequences may correspond to the same frame structure signal configuration. The frame structure signal configurations corresponding to different preamble sequences may be different or the same.

In the case where the length of the data sequence is indicated by the preamble sequence, each preamble sequence may correspond to a data sequence length. When determining the data sequence length of a frame structure signal, a preamble sequence corresponding to the data sequence length can be selected as the preamble sequence of the frame structure signal. The second communication node may determine the data sequence length according to the preamble sequence.

In the case where a data sequence length subset is indicated by the preamble sequence, each preamble sequence may correspond to a subset of data sequence lengths. The subset of data sequence lengths may belong to a set of data sequence lengths. When determining the data sequence length of a frame structure signal, the first communication node can determine the subset of data sequence lengths in which the data sequence length is located. The first communication node may select the preamble sequence corresponding to the subset of data sequence lengths as the preamble sequence of the frame structure signal. Thus, the first communication node may indicate the subset of data sequence lengths using the preamble sequence to the second communication node. Based on the subset of data sequence lengths, the second communication node may determine a data sequence length.

In the case where a subset of numbers of repetitions of the data sequence is indicated by the preamble sequence, each preamble sequence may correspond to a subset of numbers of repetitions. The subset of numbers of repetitions may belong to a set of numbers of repetitions of the data sequence. When determining the number of repetitions of the data sequence of a frame structure signal, the first communication node may determine the subset of numbers of repetitions in which the number of repetitions belong, and may select the preamble sequence corresponding to the subset of numbers of repetitions as the preamble sequence of the frame structure signal. Thus, the first communication node may indicate the subset of numbers of repetitions of the data sequence using the preamble sequence to the second communication node. Based on the subset of repetitions of the data sequence, the second communication node may determine the number of repetitions of the data sequence.

In the case where a length of the control information is indicated by the preamble sequence, each preamble sequence may correspond to a control information length. When determining the control information length of a frame structure signal, a preamble sequence corresponding to the control information length can be selected as the preamble sequence of the frame structure signal. Thus, the first communication node may indicate the control information length using the preamble sequence to the second communication node.

In the case where a subset of numbers of repetitions of the control information is indicated by a preamble sequence, each preamble sequence may correspond to a subset of numbers of repetitions. The subset of numbers of repetitions may belong to a set of numbers of repetitions of the control information. When determining the number of repetitions of the control information in a frame structure signal, the first communication node may determine the subset of numbers of repetitions in which the number of repetitions belong. The first communication node may select a preamble sequence corresponding to the subset of numbers of repetitions as the preamble sequence of the frame structure signal. Thus, the first communication node may use the preamble sequence to indicate to the second communication node the subset of numbers of repetitions of the control information. Based on the subset of numbers of repetitions of the control information, the second communication node may determine the number of repetitions of the control information.

In the case where whether to use repetitive transmissions are indicated by a preamble sequence, the preamble sequence set can be divided into two subsets. The first preamble sequence subset may correspond to the control information or data sequence using repetitive transmissions. The second preamble sequence subset may correspond to the control information or a data sequence using non-repetitive transmission. When repetitive transmissions are used for the control information or the data sequence, the preamble sequence in the first preamble sequence subset can be selected as the preamble sequence of the frame structure signal. When non-repetitive transmission is used for the control information or the data sequence, the second preamble sequence subset can be selected as the preamble sequence of the frame structure signal. Therefore, the preamble sequence can be used to indicate to the second communication node whether the repeated transmission of the control information or the data sequence is used.

### Implementation Example 6

A frame structure signal may include a frame header symbol. The frame header symbol may indicate a frame structure signal configuration. The frame structure signal configuration may include at least one: whether to use repetitive transmissions, a data sequence length, or a subset of data sequence lengths, a subset of numbers of repetitions for data sequence, a control information length, or a subset of numbers of repetitions for control information.

The data sequence with N repetitive transmissions can be sent based on the frame structure. The frame structure may include at least one of the following structures.

### Structure One

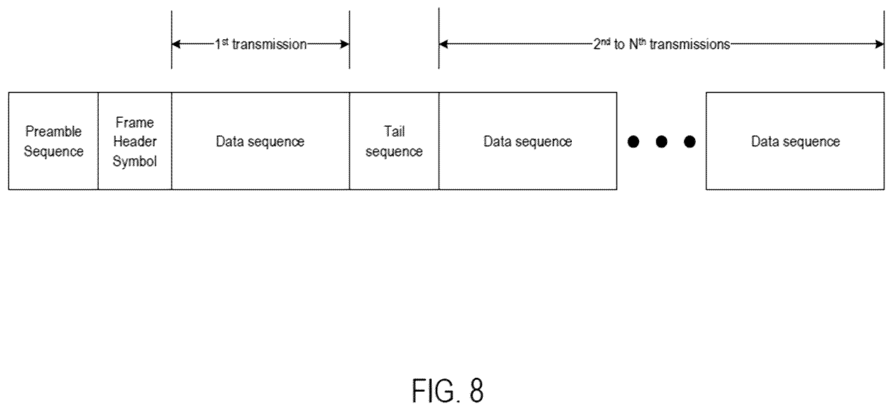

The frame structure sequentially in the time domain may include: a preamble sequence, a frame header symbol, a data sequence of the first transmission, a tail sequence, and a data sequence of the 2^{nd} transmission to the N^{th} transmission, as shown in FIG. 8. When N is equal to 1, the N repetitive transmissions can be a single transmission. In such case, the first communication node may send the data sequence once. There can be no data sequence from the 2^{nd} transmission to the N^{th} transmission. When N is greater than 1, the N repetitive transmissions can be multiple transmissions. In such case, the first communication node may send the data sequence for N times.

In this frame structure signal, the preamble sequence can be used for synchronization of the data sequence transmission. In the case of detecting the preamble sequence, the receiving end may determine the start time of the frame structure signal. In this frame structure signal, the frame header symbol can be used to indicate whether the data sequence is repeatedly transmitted or non-repeatedly transmitted, or the frame header symbol can be used to indicate a subset of the data sequence lengths, or the frame header symbol can be used to indicate the number of repetitions of the data sequence.

In the frame structure signal, the tail sequence can be used to determine the data sequence length of the data sequence. The data sequence length can be the number of data symbols included in the data sequence. In the case of detecting the tail sequence, the receiver may determine the end time of the first transmission of the data sequence, and may determine the length of the data sequence.

### Structure Two

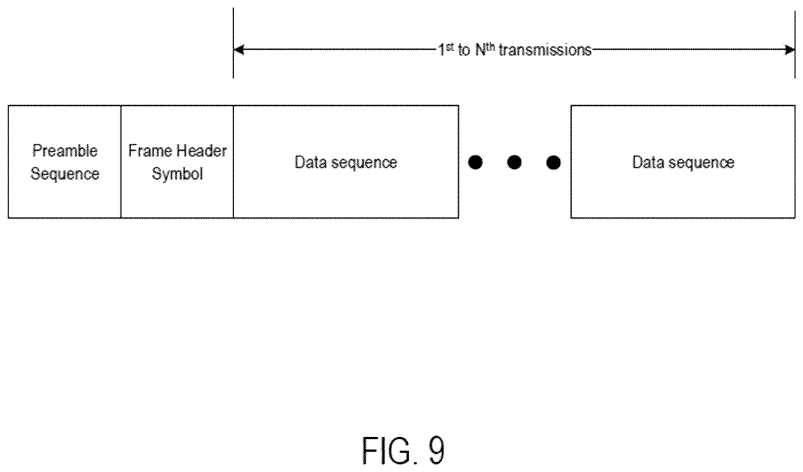

The frame structure sequentially in the time domain may include: a preamble sequence, a frame header symbol, and a data sequence with N repetitions, as shown in FIG. 9. The preamble sequence can be used for synchronization of data sequence transmission. In the case of detecting the preamble sequence, the receiving end may determine the start time of the frame structure signal. The frame header symbol can be used to indicate whether the data sequence is repeatedly transmitted or non-repeatedly transmitted, or indicate the length of the data sequence, or indicate the number of repetitions of the data sequence.

In this frame structure signal, the tail sequence can be used to determine the transmission duration of the data sequence or the data sequence length. The data sequence length can be the number of data symbols included in the data sequence.

When N is equal to 1, the N repetitive transmissions can be a single transmission. In such case, the first communication node may send the data sequence once. When N is greater than 1, the N repeated transmissions can be multiple transmissions. In such case, the first communication node may send the data sequence for N times.

### Structure Three

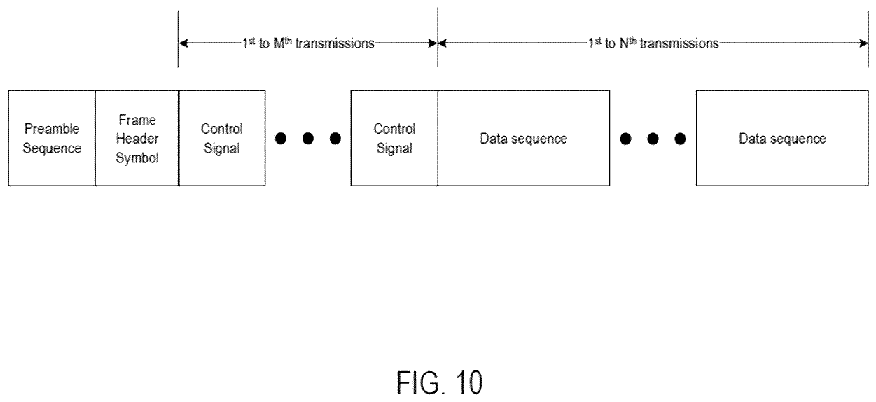

The frame structure sequentially in the time domain may include: a preamble sequence, a frame header symbol, control information with M repetitions, and a data sequence with N repetitions, as shown in FIG. 10. The preamble sequence can be used for synchronization of data sequence transmission. In such case of detecting the preamble sequence, the receiving end may determine the start time of the frame structure signal. The frame header symbol can be used to indicate whether the control information is repeatedly transmitted or non-repeatedly transmitted, or indicate the length of the control information, or indicate the number of repetitions of the control information.

When M is equal to 1, the M repetitive transmissions can be single transmission. In such case, the first communication node may send the control information once. When M is greater than 1, the M repetitive transmissions can be multiple transmissions. In such case, the first communication node may send the control information for M times. When N is equal to 1, the N repetitive transmissions can be single transmission. In such case, the first communication node may send the data sequence once. When N is greater than 1, the N repetitive transmissions are multiple transmissions. In such case, the first communication node may send the data sequence for N times.

### Structure Four

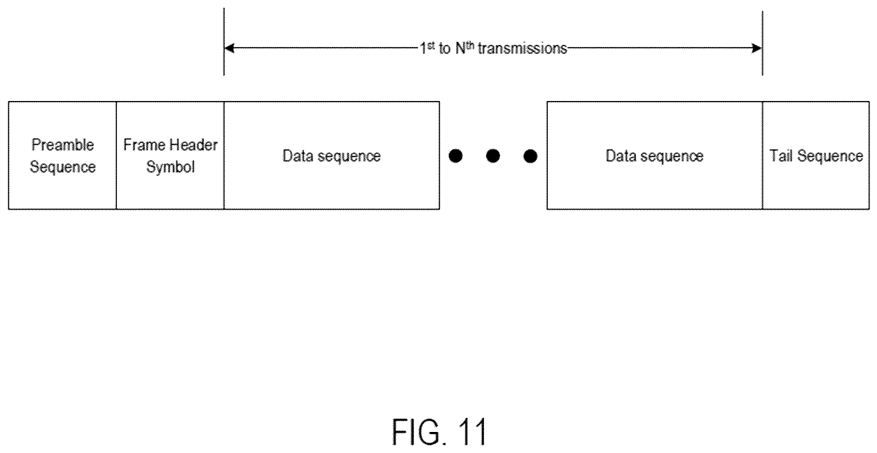

The frame structure sequentially in the time domain may include: a preamble sequence, a frame header symbol, a data sequence with N repetitions, and a tail sequence, as shown in FIG. 11. The preamble sequence can be used for synchronization of data sequence transmission. In the case of detecting the preamble sequence, the receiving end may determine the start time of the frame structure signal. The frame header symbol can be used to indicate whether the data sequence is repeatedly transmitted or non-repeatedly transmitted, or indicate the length of the data sequence.

The tail sequence can be used to determine the number of repetitions of the data sequence. In the case of detecting the tail sequence, the receiving end may determine the end time of the Nth transmission of the data sequence, and may determine the number N of repetitions of the data sequence.

When N is equal to 1, the N repetitive transmissions can be a single transmission. In such case, the first communication node sends the data sequence once. When N is greater than 1, the N repetitive transmissions are multiple transmissions. In such case, the first communication node may send the data sequence for N times.

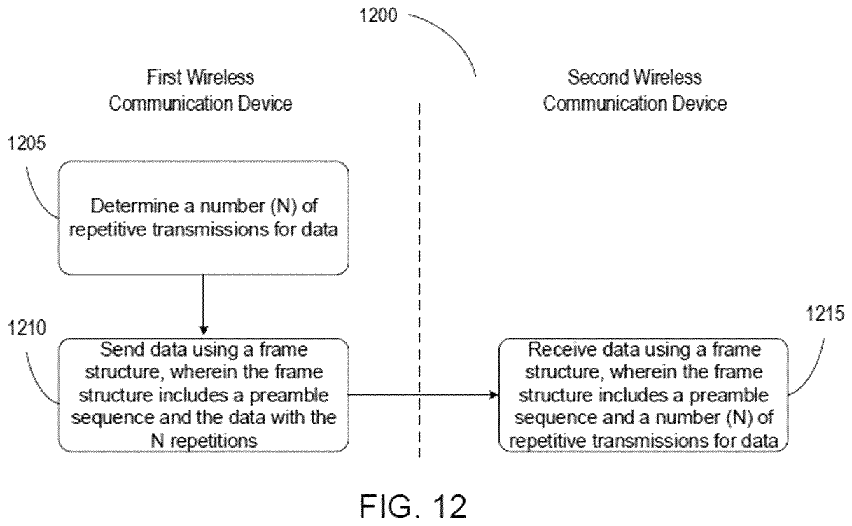

FIG. 12 illustrates a flow diagram of a method 1200 for frame structures for communication in passive/semi-passive Internet-of-Things (IoT). The method 1200 may be implemented using any one or more of the components and devices detailed herein in conjunction with FIGS. 1-2. In overview, the method 1200 may be performed by a wireless communication device, in some embodiments. Additional, fewer, or different operations may be performed in the method 1200 depending on the embodiment. At least one aspect of the operations is directed to a system, method, apparatus, or a computer-readable medium.

A first wireless communication device may determine a number (N) of repetitive transmissions for data. The first wireless communication device may send data using a frame structure to a second wireless communication device. The frame structure may include a preamble sequence and the data with the N repetitions.

In some embodiments, the frame structure may include the preamble sequence, a first one of the N repetitions, a tail sequence, and remaining ones of the N repetitions that can be arranged in above order along a time domain. In some embodiments, the frame structure may include the preamble sequence, control information with a number (M) of repetitions, and the data with the N repetitions that are arranged in above order along a time domain. In some embodiments, the frame structure may include the preamble sequence, control information for the first one of a number (M) of repetitions, a tail sequence, control information for remaining ones of the M repetitions, and the data with the N repetitions that can be arranged in above order along a time domain.

In some embodiments, the frame structure may include the preamble sequence and the data with the N repetitions that can be arranged in above order along a time domain. Prior to sending the data using the frame structure, the first wireless communication device may receive a first message from the second first wireless communication device. The first wireless communication device may determine a data sequence length of each of the N repetitive transmissions based on the message. The step of determining a length of each of the N repetitive transmissions may further comprise the following steps. Each type of first message may correspond to a data sequence length. The first wireless communication device may determine the data sequence length of each of the N repetitive transmissions according to the type of the received first message.

In some embodiments, each type of first message corresponds to a set of data sequence lengths, J≥1. The first message may contain a length indication indicating one of the set of data sequence lengths. In some embodiments, a tail sequence can be arranged after the N repetitive transmissions along the time domain.

In some embodiments, the preamble sequence can be configured to indicate an arrangement of the frame structure. The arrangements of the frame structures may include at least one of: whether to perform the repetitive transmissions, a length of data sequence, a subset of lengths of data sequence, a subset of the number of repetitive transmissions for data, a length of control signals, or a subset a number of repetitive transmissions for control signals.

In some embodiments, the frame structure further may include one or more head symbols configured to indicate an arrangement of the frame structure. The frame structure may include the preamble sequence, the one or more head symbols, the data for the first one of the N repetitions, the tail sequence, and the data for remaining ones of the N repetitions that can be arranged in above order along a time domain. The frame structure may include the preamble sequence, the one or more head symbols, and the data with the N repetitions that can be arranged in above order along a time domain. The frame structure may include the preamble sequence, the one or more head symbols, control information with a number (M) of repetitions, and the data with the N repetitions that can be arranged in above order along a time domain. The frame structure may include the preamble sequence, the one or more head symbols, the data with the N repetitions, and the tail sequence that can be arranged in above order along a time domain.

In some embodiments, a second wireless communication device may receive data using a frame structure from a first wireless communication device. The frame structure may include a preamble sequence and data with a number (N) of repetitions.

While various embodiments of the present solution have been described above, it should be understood that they have been presented by way of example only, and not by way of limitation. Likewise, the various diagrams may depict an example architectural or configuration, which are provided to use persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A wireless communication method comprising:
determining, by a first wireless communication device, a number (N) of repetitive transmissions for data; and
sending, by the first wireless communication device to a second wireless communication device, data using a frame structure,
wherein the frame structure includes a preamble sequence and the data with the N repetitions.

2. The wireless communication method of claim 1, wherein the frame structure includes the preamble sequence, a first one of the N repetitions, a tail sequence, and remaining ones of the N repetitions that are arranged in above order along a time domain.

3. The wireless communication method of claim 1, wherein the frame structure includes the preamble sequence, control information with a number (M) of repetitions, and the data with the N repetitions that are arranged in above order along a time domain.

4. The wireless communication method of claim 1, wherein the frame structure includes the preamble sequence, control information for the first one of a number (M) of repetitions, a tail sequence, control information for remaining ones of the M repetitions, and the data with the N repetitions that are arranged in above order along a time domain.

5. The wireless communication method of claim 1, wherein the frame structure includes the preamble sequence and the data with the N repetitions that are arranged in above order along a time domain.

6. The wireless communication method of claim 5, further comprising:
prior to sending the data using the frame structure, receiving, by the first wireless communication device from the second first wireless communication device, a first message; and
determining, by the first wireless communication device based on the message, a data sequence length of each of the N repetitive transmissions.

7. The wireless communication method of claim 6, wherein each type of first message corresponds to a data sequence length, the wireless communication method further comprising:
determining, by the first wireless communication device, the data sequence length of each of the N repetitive transmissions according to the type of the received first message.

8. The wireless communication method of claim 6, wherein each type of first message corresponds to a set of data sequence lengths, J≥1.

9. The wireless communication method of claim 8, wherein the first message contains a length indication indicating one of the set of data sequence lengths.

10. The wireless communication method of claim 5, wherein a tail sequence is arranged after the N repetitive transmissions along the time domain.

11. The wireless communication method of claim 1, wherein the preamble sequence is configured to indicate an arrangement of the frame structure, and wherein the arrangements of the frame structures includes at least one of: whether to perform the repetitive transmissions, a length of data sequence, a subset of lengths of data sequence, a subset of the number of repetitive transmissions for data, a length of control signals, or a subset a number of repetitive transmissions for control signals.

12. The wireless communication method of claim 1, wherein the frame structure further includes one or more head symbols configured to indicate an arrangement of the frame structure.

13. The wireless communication method of claim 12, wherein the frame structure includes the preamble sequence, the one or more head symbols, the data for the first one of the N repetitions, the tail sequence, and the data for remaining ones of the N repetitions that are arranged in above order along a time domain.

14. The wireless communication method of claim 12, wherein the frame structure includes the preamble sequence, the one or more head symbols, and the data with the N repetitions that are arranged in above order along a time domain.

15. The wireless communication method of claim 12, wherein the frame structure includes the preamble sequence, the one or more head symbols, control information with a number (M) of repetitions, and the data with the N repetitions that are arranged in above order along a time domain.

16. The wireless communication method of claim 12, wherein the frame structure includes the preamble sequence, the one or more head symbols, the data with the N repetitions, and the tail sequence that are arranged in above order along a time domain.

17. A wireless communication method, comprising:
receiving, by a second wireless communication device from a first wireless communication device, data using a frame structure,
wherein the frame structure includes a preamble sequence and data with a number (N) of repetitions.

18. A second wireless communication device, comprising:
at least one processor configured to:
receive, via a receiver from a first wireless communication device, data using a frame structure;
wherein the frame structure includes a preamble sequence and data with a number (N) of repetitions.

19. A first wireless communication device, comprising:
at least one processor configured to:
determine a number (N) of repetitive transmissions for data; and
send, via a transmitter to a second wireless communication device, data using a frame structure;
wherein the frame structure includes a preamble sequence and the data with the N repetitions.

20. The first wireless communication device of claim 19, wherein the frame structure includes the preamble sequence, a first one of the N repetitions, a tail sequence, and remaining ones of the N repetitions that are arranged in above order along a time domain.
